(19) United States
(12) Patent Application Publication
(10) Pub. No.: US 2010/0117924 A1
(43) Pub. Date: May 13, 2010

(54) SYSTEM FOR MOUNTING AN ANTENNA THROUGH AN APERTURE OF A SURFACE

(75) Inventors: Charles J. Provenzano, Houston, TX (US); Jerry C. Drew, Grapevine, TX (US); Michael Leung, Missouri City, TX (US)

Correspondence Address: CONLEY ROSE, P.C.;David A. Rose, P. O. BOX 3267, HOUSTON, TX, 77253-3267, US

(73) Assignee: ELECTRONIC CUSTOM DISTRIBUTORS, INC., Houston, TX (US)

(21) Appl. No.: 12/269,626

(22) Filed: Nov. 12, 2008

(51) Int. Cl. H01Q 1/12

(52) U.S. Cl. 343/878

(57) ABSTRACT

A system for mounting an antenna through the aperture of a surface. At least some of the illustrative embodiments are apparatuses comprising a housing with an interior cavity comprising a first end, a circular second end, a plurality of fingers that extend from the circular second end, and a compression member that threadingly couples to the circular second end, the compression member configured to compress the plurality of fingers.

### BACKGROUND

A residence or a small office may comprise various audio, video and communications systems (e.g., High Definition Television (HDTV) system, intercom system, telephone system, or home computer networking) that may be installed throughout out the residence or the small office. Structured wiring is a wiring system enabling a centralized distribution of the various audio, video and communication systems. A structured wiring enclosure is installed in a service area (e.g., air-conditioned closets or an unconditioned space such as a garage, an attic or a basement) of the residence, and the structured wiring enclosure provides the central distribution point for the audio, video and communication system.

The structured wiring enclosure is a metallic enclosure that comprises components for the various audio, video and communication systems. For example, a computer networking wireless router may be installed within the structured wiring enclosure as a part of home computer networking system. However, installing the wireless router within a metallic structured wiring enclosure attenuates the signals transmitted and received from the wireless router.

### BRIEF DESCRIPTION OF THE DRAWINGS

For a detailed description of exemplary embodiments, reference will now be made to the accompanying drawings in which:

FIG. 1 shows a structured wiring system in accordance with some of the embodiments;

FIG. 2A shows an antenna mount in accordance with some of the embodiments;

FIG. 2B shows an antenna mount in accordance with some of the embodiments; and

FIG. 3 shows an antenna mount in accordance with some of the embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

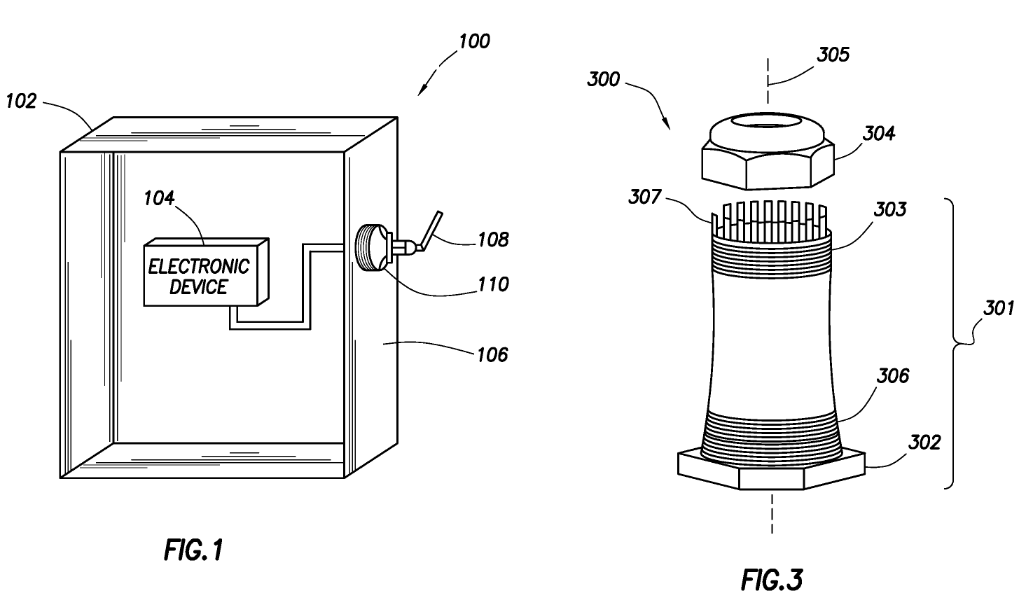

FIG. 1 illustrates a structured wiring system 100 in accordance with at least some of the embodiments. The structured wiring system 100 comprises a structured wiring enclosure 102 and an antenna mount 110. The antenna mount 110 may be placed at any suitable location of the structured wiring enclosure 102. For example, the antenna mount may be placed in the top panel, the bottom panel or the side panels of the structured wiring enclosure. In some structured wiring enclosures, the antenna mount 110 is placed on the side panel 106 of the structured wiring enclosure 102, and the antenna mount 110 is coupled to the structured wiring enclosure 102 through an aperture in the structured wiring enclosure 102. In the various embodiments, the aperture in the structured wiring enclosure 102 is a pre-punched knockout, but other apertures may be equivalently used. The antenna mount 110 retains an antenna 108, with the antenna 108 protruding externally from the structured wiring enclosure 102. In at least some embodiments, the antenna 108 is electrically coupled to an electronic device 104 (e.g., a computer networking device such as a modem, a router, or a switch) within the structured wiring enclosure 102. The antenna 108 communicates in a wireless communication protocol (e.g., IEEE 802.11 standard or IEEE 802.15.4 standard).

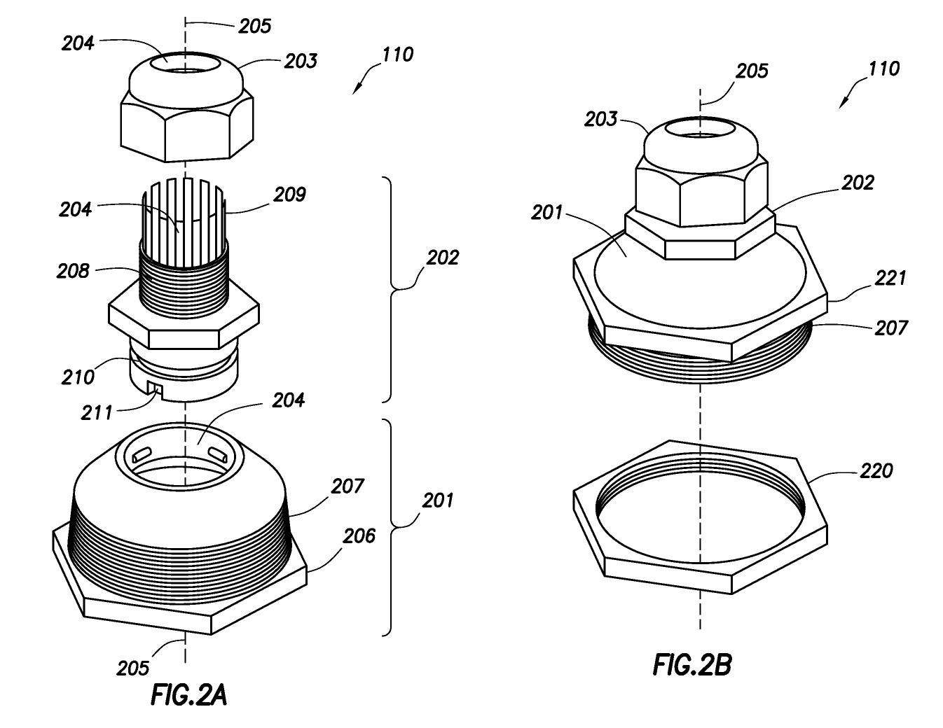

FIG. 2A illustrates an antenna mount 110 in accordance with at least some of the embodiments. In particular, FIG. 2 illustrates the antenna mount 110 comprising members 201, 202 and 203 separated from each other. Each of the members 201, 202 and 203 defines an interior cavity 204 about a central axis 205. The member 201 comprises an end 206 of the antenna mount 110, and the member 201 comprises a circular segment 207 that extends from the end 206 towards the second member 202. In the particular embodiment, the outside diameter of the end 206 is in the form of a polygon and the circular segment 207 is threaded. In other embodiments, the outside diameter of the end 206 may be of any shape such as a circle, a square or a rectangle and the circular segment 207 may comprise a snap-fit interface. The member 201 couples to the aperture of the structured wiring enclosure by way of the circular segment 207 (e.g., a threaded connection or a snap-fit connection). When the member 201 couples to the aperture, the end 206 abuts the inside of a panel of the structured wiring enclosure and the circular segment 207 protrudes outside of the panel of the structured wiring enclosure.

In at least some of the embodiments, the member 202 telescopes within the member 201. In particular, the member 202 is telescoped within the member 201 by way of a snap-fit connection using the snap-fit interface 210. In other embodiments, the member 202 telescopes within the member 201 by way of a threaded connection. The member 202 and the member 201 rotate relative to each other. The relative rotation between the member 201 and the member 202 is utilized to point the antenna in any suitable direction. In the particular embodiment, the relative rotation between the member 201 and the member 202 is facilitated by the notch 211. The member 202 comprises an end 208 of the antenna mount 110. In the particular embodiment, the end 208 is circular, threaded, and the outside diameter of end 208 is smaller than the outside diameter of the end 206. A plurality of fingers 209 extend from the end 208, and each of the plurality of fingers 209 defines an axis that is substantially parallel with the central axis 205.

A compression member 203 couples to the end 208 of the member 202. The compression member 203 compresses the distal ends of each of the plurality of fingers 209 towards the central axis 205. The compressing of the plurality of fingers 209 retains the antenna as the antenna protrudes from end 208 of the antenna mount 110. In the particular embodiment, the compression member 203 is coupled to the end 208 by way of a threaded connection. In other embodiments, the compression member 203 may be coupled to the end 208 in any suitable way, such as by way of a snap-fit connection.

Combined the members 201, 202 and 203 retain an antenna within the antenna mount 110, and couple the antenna mount 110 with the antenna to the aperture of the structured wiring enclosure. In at least some of embodiments, an antenna is slidably disposed along the central axis 205 in the interior cavity 204 defined by the members 201 and 202. The compression member 203 couples to the member 202 to retain the antenna along the central axis 205. As previously discussed, the antenna electrically couples to an electronic device to communicate in a suitable wireless communication protocol.

FIG. 2B illustrates an alternative embodiment of the antenna mount 110. In particular, FIG. 2B illustrates an antenna mount 110 with the member 202 telescoped within the member 201, and the compression member 203 coupled to the member 202. The member 201 comprises a circular segment 207 that extends from a shoulder 221, and the circular segment 207 is threaded. A fastening member 220 defines an interior cavity about the central axis 205, and the fastening member 220 couples to the member 201 of the antenna mount 110. In the particular embodiment, the fastening member 220 is threadingly coupled to the circular segment 207 of the member 201. In other embodiments, the fastening member 220 may be coupled to the circular segment 207 of the member 201 using a snap-fit connection. In at least some embodiments, the antenna mount 110 is disposed through an aperture of a structure wiring enclosure, and the fastening member 220 is coupled to the member 201 of the antenna mount 110 to fasten the antenna mount 110 to the structured wiring enclosure.

FIG. 3 illustrates a yet still another embodiment of the antenna mount 300 comprising a cylindrical body 301 and a compression member 304. The cylindrical body 301 defines an interior cavity about the central axis 305. The cylindrical body comprises an end 302 and a circular end 303. In the particular embodiment, the outside diameter of the end 302 is in the form of a polygon. In other embodiments, the outside diameter of the end 302 may be of any shape such as a circle, a square or a rectangle. The cylindrical body 301 is coupled to an aperture of structure wiring enclosure by way of the segment 306 (e.g., a threaded connection or a snap-fit connection). A plurality of fingers 307 extend from the circular end 303, and each of the plurality of fingers 307 defines an axis that is substantially parallel with the central axis 305. In at least some embodiments, a compression member 304 couples to the circular end 303, and the compression member 203 compresses the distal end of each of the plurality of fingers 209 towards the central axis 205.

The above discussion is meant to be illustrative of the principles and various embodiments of the present invention. Numerous variations and modifications will become apparent to those skilled in the art once the above disclosure is fully appreciated. For example, the wiring enclosure may be any enclosure that requires an externally mounted antenna. Moreover, the antenna 108 may communicate in any wireless communication protocol such as Worldwide Interoperability for Microwave Access (WiMAX), Global System for Mobile communications (GSM), or Code division multiple access (CDMA). It is intended that the following claims be interpreted to embrace all such variations and modifications.

What is claimed is:

1. An apparatus comprising:
a housing with an interior cavity comprising:
a first end;
a circular second end;
a plurality of fingers that extend from the circular second end; and
a compression member that threadingly couples to the circular second end, the compression member configured to compress the plurality of fingers.

2. The apparatus as defined in claim 1 wherein the outside diameter of the first end is larger than the outside diameter of the circular second end;

3. The apparatus as defined in claim 1 wherein the housing further comprises a first member that comprises the first end and a second member that comprises the second circular end, and the second member telescoped within the first member.

4. The apparatus as defined in claim 3 wherein the second member is telescoped within the first member by way of at least one selected from the group consisting of: a snap-fit connection; and a threaded connection.

5. The apparatus as defined in claim 3 wherein the first member and the second member rotate relative to each other.

6. The apparatus as defined in claim 1 wherein an outside diameter of the first end is of polygonal shape, and a circular threaded segment extends from the polygonal first end towards the second end.

7. The apparatus as defined in claim 1 wherein the housing threadingly couples to an aperture of a structured wiring enclosure such that the antenna protrudes externally from the structured wiring enclosure.

8. The apparatus as defined in claim 1 wherein the housing is snap-fit to an aperture of a structured wiring enclosure such that the antenna protrudes externally from the structured wiring enclosure.

9. A system comprising:
a cylindrical body that defines an interior cavity about a central axis;
a first end of the cylindrical body configured to couple to an aperture through a surface;
a second end having a plurality of fingers, each of the fingers define an axis substantially parallel to the central axis; and
a compression member configured to couple to the second end, and to compress the fingers towards the central axis.

10. The system as defined in claim 9 wherein the compression member couples to the second end by way of at least one selected from the group consisting of: a snap-fit connection; and a threaded connection

11. The system as defined in claim 9 wherein the aperture is an aperture of a structured wiring enclosure.

12. The system as defined in claim 9 wherein the first end is configured to couple to the aperture by way of at least one selected from the group consisting of: a snap-fit connection; and a threaded connection

13. The system as defined in claim 9 wherein the cylindrical body comprises a first member and a second member, the first member comprises the first end and the second member comprises the second end.

14. The system as defined in claim 13 wherein the second member is telescoped within the first member.

15. The system as defined in claim 13 wherein the second member is telescoped within the first member by way of at least one selected from the group consisting of: a snap-fit connection; and a threaded connection.

16. The system as defined in claim 13 wherein the first member and the second member rotate relative to each other.

17. The system as defined in claim 9 wherein the system is configured to retain an antenna.

18. A system comprising:
a structure wiring enclosure;
an antenna mount configured to couple to an aperture of the structured wiring enclosure, the antenna mount further configured to retain an antenna such that the antenna protrudes externally from the structured wiring enclosure.

19. The system as defined in claim 18 wherein the antenna mount is configured to couples to the aperture of the structured wiring enclosure by way of at least one selected from the group consisting of: a threaded connection; and a snap-fit connection.

20. The system as defined in claim 18 further comprising an electronic device configured to couple to the antenna, the electronic device is at least one selected from the group consisting of: a router; a modem; and a switch.
